(19) United States
(12) Patent Application Publication
(10) Pub. No.: US 2024/0206501 A1
(43) Pub. Date: Jun. 27, 2024

(54) METHODS OF MAKING PLANT-BASED EXTRACTS AND ASSOCIATED PLANT-BASED FOOD PRODUCTS

(71) Applicant: WhatIF F&I Pte Ltd, Singapore (SG)

(72) Inventors: Sylvie CHAU, Paris (FR); Christoph LANGWALLNER, Singapore (SG); Margit LANGWALLNER, Singapore (SG); Chong Jin LOY, Singapore (SG); Vinod VALLAYIL, Singapore (SG)

(21) Appl. No.: 18/568,673

(22) PCT Filed: Jun. 11, 2022
(86) PCT No.: PCT/SG2022/050403

§ 371 Date: Dec. 8, 2023

(30) Foreign Application Priority Data
Jun. 11, 2021 (SG) 10202106273Y

(51) Int. Cl. A23L 2/02; A23L 2/84; A23P 10/47

(52) U.S. Cl. CPC A23L 2/02; A23L 2/84; A23P 10/47

(57) ABSTRACT

The present invention relates to methods of producing a plant-based extract from Vigna subterranea and consumable products comprising the plant-based extract obtained from Vigna subterranea. In one embodiment, the method comprises flaking the Vigna subterranea seeds; subjecting the flaked Vigna subterranea to wet milling to obtain a slurry; subjecting the slurry to enzyme liquefaction; hydrolysing the slurry in water; dehydrating the hydrolysed starch to obtain a dehydrated Vigna subterranea (VS) extract; and reducing the particle size of the dehydrated VS extract by milling to obtain a micronized VS extract having an average particle size of less than 200 microns.

### TECHNICAL FIELD

This invention relates to methods of making a plant-based extract from Vigna subterranea and its use in beverages and consumable food products.

### BACKGROUND

Consumers are increasingly tending toward a non-dairy plant-based diet which includes cereal, legumes, seeds, nuts, fruits, and vegetables because of varied reasons, including a desire for positive health effects on the human body and awareness of the environmental impact of dairy farming practises and its carbon emissions. In particular, this has resulted in an increased consumption of non-dairy beverages. In addition, individuals with cow's milk allergy, lactose intolerance, and hypocholesterolemia also have a higher preference for these non-dairy beverages.

Various raw materials are used to produce non-dairy plant-based beverages. Historically, especially in Asia, soy has been used in many parts of the world as a source of plant protein in products such as soy milk, tofu and fermented tempeh because of their ease of use and good flavour profile. More recently, non-soy raw materials have also been utilized to produce plant milk including oat, almond, pecan, pea, lupin, rice, hemp, walnut, cashew, hazel nut, coconut, tiger nut.

The Vigna subterranea (VS) is a legume native to West Africa that is known for its relatively high protein and micronutrients (e.g. zinc, iron, calcium, and potassium) which are higher than cereals. It is a drought-tolerant crop and can thrive in poor soils where other crops fail. VS seeds contain about 20% protein, 60% carbohydrates and 7% oil which makes it a potential component of regenerative future food and nutritional security issues especially in developing communities. For these reasons, VS has been labelled as a whole food and an important source of protein by the Food and Agriculture Organization of the United Nations. The colour of the seeds vary from white, cream, red, black and in some cases mottled with colours such as brown, red or black.

VS are consumed mainly in homes in various modes: boiled and eaten plain; boiled and cooked with maize or other meals; roasted, boiled and mashed to produce a relish commonly used in sadza, a maize porridge; pounded to flour and boiled to produce a stiff porridge; boiled or roasted salted and served as a snack; boiled and sieved to make a plant-based “milk” beverage.

Three major problems limiting the large-scale commercial use of VS as a nutritious source of plant-based proteins is the hard-to-mill phenomenon, hard-to-cook phenomenon, and need-to-separate phenomenon. Firstly, VS requires very tedious and manual processing that includes soaking overnight and/or blanching with hot water to soften the hard seed coat and then manually removing the seed coat (dehulling). Secondly, the dehulled seeds need to be processed by boiling for 3-4 hours or roasted or pounded/milled into smaller fragments to be cooked and eaten, as evidenced by traditional methods of preparations. Thirdly, when the seeds are cooked into a slurry to make a plant “milk” beverage, the insoluble solid plant residues have to be separated from the liquid part by using filtering material such as double-layered cheesecloth, muslin cloth, physical sieves, centrifugation or decanting in order to remove the insoluble solid plant residues to obtain a palatable VS beverage suitable for consumption. Moreover, the separation of insoluble solid plant residues will result in loss of proteins, fibers, lipids and other nutrients and generate significant amounts of waste material.

In soy drink production, there is a similar need to separate the insoluble plant residues (okara) from the liquid. It is estimated that during commercial production, every litre of soy drink generates about 170 g of okara (˜17%). Globally, it is estimated that more than four million metric tons of okara are generated on an annual basis from soy drink production. Commercial scale production of VS beverage is currently non-existent due to the major impediments described, but it is reasonable to estimate that similar amounts of insoluble plant residue wastes will be generated for VS beverage using conventional methods. These challenges pose significant hurdles to its preparation and utility due to the slow manual process required to dehull the seeds before use, the additional cost involved to justify the long heating and cooking time required, and the generation of insoluble plant waste residue. Furthermore, reports suggest that extended cooking time alters the palatability and protein digestibility profile of VS, further decreasing its potential as an attractive, nutritional, viable and sustainable plant-based protein source.

Accordingly, a need exists for a novel method for producing a plant-based extract from Vigna subterranea and its use in making quality VS beverages and consumable food products that eliminates or significantly reduces the impediments mentioned hereinabove or at least to provide an alternative.

### SUMMARY OF INVENTION

In accordance with a first aspect of this invention, a method of producing a plant-based extract from Vigna subterranea is provided. In one embodiment, the method comprises flaking Vigna subterranea seeds; subjecting the flaked Vigna subterranea to wet milling to obtain a slurry; subjecting the slurry to enzyme liquefaction; hydrolysing the slurry in water; dehydrating the hydrolysed starch to obtain a dehydrated Vigna subterranea (VS) extract; and reducing the particle size of the dehydrated VS extract by milling to obtain a micronized VS extract having an average particle size of less than 200 microns.

In one embodiment, the method further comprises subjecting the micronized VS extract to a secondary enzyme treatment.

In one embodiment, the enzyme liquefaction step comprises adding one or more enzymes selected from the group consisting of amylase enzyme or a combination of amylases (alpha- and beta-amylase) to the slurry to digest and liquefy the starch in the slurry.

In another embodiment, the method comprises flaking Vigna subterranea seeds; subjecting the flaked Vigna subterranea to wet milling to obtain a slurry; heating the slurry to obtain a hydrolysed starch; dehydrating the hydrolysed starch to obtain a dehydrated Vigna subterranea (VS) extract; and reducing particle size of the dehydrated VS extract by milling to obtain a micronized VS extract having an average particle size of less than 200 micron.

In yet another embodiment, the method comprises decompounding Vigna subterranea (VS) seeds by treating the VS seeds with at least one enzyme to obtain a decompounded VS slurry; heating the decompounded VS slurry; and dehydrating the VS slurry to obtain a micronized VS extract having an average particle size of less than 200 microns.

In accordance with a second aspect of this invention, a consumable product comprising a plant-based extract obtained from Vigna subterranea is provided.

### BRIEF DESCRIPTION OF THE DRAWINGS

FIG. 1 is a graph showing an example of VS size reduction particle size distribution.

FIG. 2 is a graph showing the foamability and foam stability of VS Beverage B1, B2 and B3 made using VS extracts from Examples 1, 2 and 3, respectively.

FIG. 3 are pictures showing the foamability and foam stability of VS Beverage B1, B2 and B3 made using VS extracts from Examples 1, 2 and 3, respectively.

### DETAILED DESCRIPTION

The present invention relates to a method of producing a plant-based extract from Vigna subterranea (VS), also known as bambara groundnut. The invention is directed to improved techniques for making VS extract, VS beverage and consumable food products incorporating the VS extract or VS beverage.

In accordance with one aspect of the invention, a method for producing a plant-based extract from Vigna subterranea (VS) is provided. In one embodiment, the method comprises cleaning the VS and flaking the VS to increase surface area for high efficacy wet milling to produce a wet VS slurry with reduced particle size. The wet slurry is subject to an enzyme liquefaction and hydrolysis step in the presence of water to obtain a liquefied VS starch. The liquefied VS starch is then dehydrated to remove water content to obtain a dehydrated VS extract. The dehydrated VS extract may be further processed by milling to reduce the particle size to less than 200 microns.

In this embodiment, the VS slurry contains a VS:water ratio selected based on the desired characteristics of the VS extract to be produced. The VS:water ratio ranges from 1:1 to 1:2. The enzyme liquefaction step involves adding one or more enzymes to digest and liquefy the starch in the VS:water slurry. The enzyme liquefaction treatment is performed under controlled conditions. The treatment takes place at a temperature of 30° C. to 85° C., preferably 50° C. to 85° C., for a duration of 15 to 60 minutes and at a pH 5 to 7 to hydrolyse the starch in the VS:water slurry. The enzymes used in this embodiment include an amylase enzyme or a combination of amylases (alpha- and beta-amylase), preferably an alpha-amylase to cleave D-14-glucosidic bonds. Other enzymatic treatments can be added to facilitate proteolysis, including treatment with cellulase, hemi-cellulase, xylanase, arabinase, glucoamylase and maltogenic amylase based on the desired organoleptic profile of the VS extract or the VS beverage.

The size reduction milling step may be carried out using a pin mill, a rotor mill, an air jet sieve mill, an air classifier mill apparatus or a combination thereof. Generally, the size of the VS particles can be modified accordingly in the milling step to the desired characteristics of the VS extract. The micronized VS extract can be subject to further processing steps such as reconstitution, addition of pre-mix, homogenization and thermal treatment to complete the production of whole pulse VS beverage.

“Reconstitution” as used herein means to prepare the VS extract in a liquid state and diluting the liquid VS extract.

“Addition of pre-mix” as used herein refers to the addition of nutritional components such as vitamins, minerals, fats, proteins, fibres, salts, fruits/fruit preparations, flavours or combination thereof.

“Homogenization” as used herein refers to processes used to create a mixture of mutually non-soluble liquids the same throughout into a uniform suspension.

“Thermal treatment” as used herein refers to a range of heat procedures designed to destroy microbial contents in VS extract, VS beverage or consumable food products. Thermal treatments include pasteurization, high-temperature-short-time treatments, sterilization.

In one embodiment, the method further comprises subjecting the micronized VS extract to a further processing step involving a secondary enzyme treatment. The secondary enzyme treatment may be operated under the same or different conditions as the enzyme liquefaction step. The secondary enzyme treatment step may be performed at a temperature ranging from 30° C. to 85° C., for a duration of 15 to 60 minutes and at a pH of 5-7. The enzymes used in the secondary enzyme treatment step may be the same or different from the enzymes used in the enzyme liquefaction step. The enzymes include an amylase enzyme or a combination of amylases (alpha- and beta-amylase), preferably an alpha-amylase to cleave D-14-glucosidic bonds. Other enzymatic treatments can be added to facilitate proteolysis, including treatment with cellulase, hemi-cellulase, xylanase, arabinase, glucoamylase and maltogenic amylase based on the desired organoleptic profile of the VS extract or the VS beverage.

In another embodiment, the method comprises cleaning the VS and flaking the VS to increase surface area for high efficacy wet milling to produce a wet VS slurry with reduced particle size. The wet VS slurry is subject to heat treatment at a temperature of 50° C. to 85° C., preferably 60° C. to 85° C., more preferably 70° C. to 85° C. to hydrolyse the starch. The hydrolysed VS starch is then dehydrated to remove water content to obtain a dehydrated VS extract. The dehydrated VS extract may be further processed by milling to further reduce the particle size to less than 200 microns. The size reduction milling step may be carried out using a pin mill, a rotor mill, an air jet sieve mill, an air classifier mill apparatus or a combination thereof.

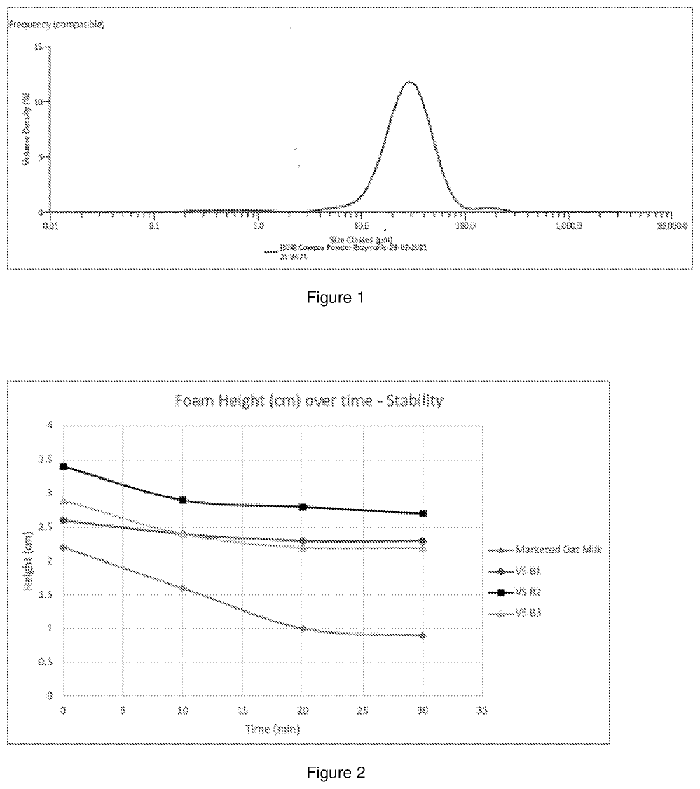

Particle size distribution was analysed using a Mastersizer 3000 (Malvern Instruments Ltd., UK). An example of VS size reduction particle size distribution is shown in FIG. 1. Generally, the size of the VS particles can be modified accordingly in the milling step to the desired characteristics of the VS extract. The micronized VS extract can be subject to further processing steps such as reconstitution, addition of pre-mix, homogenization and thermal treatment to complete the production of whole pulse VS beverage.

The method in this embodiment may further comprise subjecting the micronized VS extract to a further processing step involving enzyme liquefaction. The enzyme liquefaction step is performed under controlled conditions in the presence of water. The conditions include subjecting the micronized VS extract to heat at a temperature ranging from 30° C. to 85° C., for a duration of 15 to 60 minutes and at a pH 5 to 7. The enzymes used in this embodiment include an amylase enzyme or a combination of amylases (alpha- and beta-amylase), preferably an alpha-amylase to cleave D-14-glucosidic bonds. Other enzymatic treatments can be added to facilitate proteolysis, including treatment with cellulase, hemi-cellulase, xylanase, arabinase, glucoamylase and maltogenic amylase based on the desired organoleptic profile of the VS beverage.

In yet another embodiment, the method comprises cleaning the VS and flaking the VS to increase surface area for high efficacy wet milling to produce a wet VS slurry with reduced particle size. The VS particle size is preferably less than 200 microns. The size reduction wet milling step may be carried out using a pin mill or a rotor mill apparatus or a combination thereof. The VS slurry is subject to heat treatment at a temperature of 50° C. to 85° C. to hydrolyse the VS starch. The hydrolysed VS starch is then dehydrated to remove water content. A VS extract containing size reduced VS is produced. The VS extract can be subject to further processing steps such as reconstitution, addition of pre-mix, fermentation, homogenization and pasteurization to complete the production of whole pulse VS beverage.

“Fermentation” as used herein refers to processes that produce desirable biochemical changes in the composition of VS through the actions of microorganisms or enzymes. In one embodiment, fermentation involves incubating the VS extract at a temperature of 30° C. to 45° C. in the presence of lactic-acid producing microorganisms to develop textural and taste characteristics.

In a further embodiment, the method comprises treating VS with enzymes to decompound the rigid VS seed coat having principal constituents such as cellulose microfibrils and pectin.

Mixtures of enzymes comprising pectinases, arabinase, xylanases and hemicellulose can be used to target the different seed coat components under controlled conditions. The VS may subject to further decompounding by milling to reduce the particle size to less than 200 microns. The size reduction milling step may be carried out using a pin mill or a rotor mill apparatus or a combination thereof. The VS extract or the micronized VS extract is subject to heat treatment at a temperature of 50° C. to 85° C. to hydrolyse the starch. The hydrolysed VS starch is then dehydrated to remove water content to obtain a dehydrated VS extract. The dehydrated VS extract can be subject to further processing steps such as reconstitution, addition of pre-mix, fermentation, homogenization and thermal treatment to complete the production of whole pulse VS beverage.

In the methods of the present invention, any suitable dehydration (or drying) method may be employed to dehydrate the VS starch to remove the water content to obtain a dehydrated VS extract. Such method includes, but not limited to, the use of heat, infrared, rotary drying, vacuum drying, flash drying, spray drying or a combination thereof.

In the methods of the present invention, any suitable flaking method can be employed to flake the VS seeds. In one embodiment, flaking is carried out by soaking in water to soften the VS, followed by breaking down the VS into grits by a milling process. Plate mill, roller mill, hammer mill may be employed.

The methods of the present invention have several advantages. The methods improve processing time and improve the yield of VS extract by using the entire VS nut. The methods reduce waste and retain nutritional and functional qualities of the VS extract. The VS extract when used in producing VS beverage, addresses the mouthfeel and palatability of the VS beverage and associated food products produced using the VS extract.

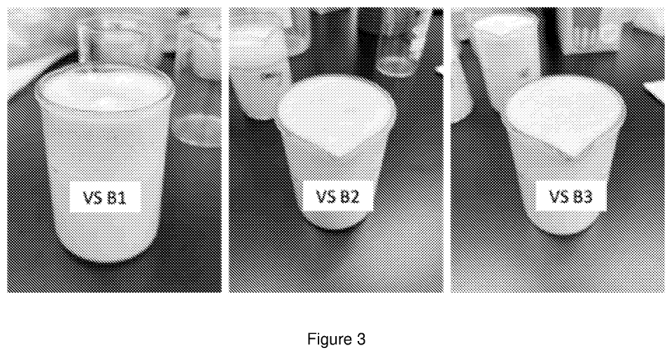

In another aspect of the present invention, a beverage comprising a VS extract prepared by the methods of the present invention is provided. The beverage (or VS beverage) is prepared by mixing VS extract in the beverage. The VS beverage produced using the VS extract produced by the methods of the present invention generally has a total solids ranging from 5% to 15% by weight, a pH from 5 to 7 and a viscosity ranging from 3 to 100 cP @ shear rate 100 s⁻¹, (or 3 to 100 mPa·s) Brix 5-20. The VS beverage has properties that make it easy to create a stable foam or aeration or froth under heating conditions. Foam/froth generation are devoid of stabilizers, emulsifiers or thickeners to enhance physical stability of the beverage. Examples of foamability and foam stability are shown in FIGS. 2 and 3. Foamed VS beverage is suitable for beverages including coffees and teas. Examples include latte, cappuccino, mocha, macchiato, piccolo or babyccino. The foaming and aeration properties of the VS beverage is suitable as functional ingredients for incorporation into ice creams, soft serve ice creams, butter, cream, custards and associated foods. It is also suitable for foods that require formation of stiff peaks generated by mechanical shear such as meringue.

VS beverage produced using the VS extract maximizes the benefits of proteins, fats and soluble and insoluble solids (such as soluble and insoluble fibers, etc.) of VS. In contrast, conventional methods for producing VS beverage require the seeds to be dehulled prior to cooking and the insoluble solids residues are separated from the beverage after cooking and are discarded as waste. The methods of the present invention retain more than 90% of the nutritional value of VS and produces minimal to no waste residues that otherwise has to be discarded. The methods also enable industrial scale operations for VS beverage production.

The methods of the present invention can be used to produce VS beverage containing different flavours and additives. Such flavours include, but not limited to, chocolate, coffees, teas, vanilla, mint, strawberry, blueberry, raspberry, mango, pineapple, coconut, banana, taro, pear, papaya, longan, pandan, ginger, nutmeg, cloves. The additives include, but not limited to, natural sugars, low GI sugars, salt, fruit pieces, fruit puree, carrot, avocado, ube. The VS beverage can also include anti-oxidants such as cinnamon, cardamon, turmeric, beetroot, goji berry Ayurvedic and traditional Chinese medicinal botanicals. The VS beverage can be fortified with minerals and vitamins, including vitamin D, B12, calcium, zinc.

The methods of the present invention produce VS extract and VS beverage that are suitable for producing associated plant-based consumable food products such as powdered plant-based beverage, dairy-alternative evaporated milk, dairy-alternative condensed milk, ice cream, yoghurts, fermented beverages, fermented kefir drinks, prebiotic and probiotic beverages containing different bacterial strains with health benefits, and novel ambient products that utilize VS extract and/or VS beverage as a starting material or as functional ingredients. Another aspect is the use of VS extract and VS beverage to support the co-culture and maintenance of dairy and non-dairy probiotic strains for the novel co-expression of synergistic benefits to be added to food products to enhance their nutritional properties.

The VS extract and VS beverage produced from the methods of the present invention can be combined with other plant extracts and/or beverage including soy, pea, oats, sesame, almonds, chickpeas, cashew, hazelnut, coconut, macadamia, lentils, quinoa, sorghum, hemp, rice, chia seeds, peanut, barley, amaranth, pumpkin seed, etc. to produce plant-based foods.

These plant-based foods can contain combinations of probiotic microbial strains to confer probiotic benefits.

In one embodiment, the VS beverage and/or VS extract is used to produce dairy-free set yoghurts, stirred yoghurts and ambient stable or chilled drink yoghurts.

The VS extract of the present invention can also be used as precursors for soups and shakes, flavors, sauces and spreads used in savoury products, and bio-fermentation process applications into miso like products, savoury tastemaker, soy sauce replacement and consumables comprising extruded food products and tempeh like high protein snacks. Extruded snacks include puff snacks, breakfast cereal like products, pasta, meat alternatives and protein alternatives.

To facilitate a better understanding of the present invention, the following examples of specific embodiments are given. In no way should the following examples be read to limit or define the entire scope of the invention. One skilled in the art will recognize that the examples set out below are not an exhaustive list of the embodiments of this invention.

### EXAMPLES

### Example 1

A batch of VS was cleaned and flaked. The flaked VS underwent a wet milling process to produce a wet VS slurry. The wet VS slurry was then subject to heat treatment at a temperature ranging from 50° C. to 85° C. The hydrolysed VS starch was then dehydrated to remove water content. The dehydrated VS extract was further processed in a disc mill to reduce the particle size to less than 200 microns. The VS extract was reconstituted into liquid form to produce a whole pulse VS beverage. The foamability and foam stability of the VS beverage obtained by this method is shown in FIGS. 2 and 3 as B1.

### Example 2

A batch of VS was cleaned and flaked. The flaked VS underwent a wet milling process to produce a wet VS slurry. The wet VS slurry was then subject to an enzyme liquefaction which involved adding amylase to the wet VS slurry. The enzyme liquefaction treatment was performed under a temperature of about 50° C. for a period of about 30 minutes and at a pH 7. The slurry was then hydrolysed in the presence of water to obtain a liquefied VS starch. The liquefied VS starch was dehydrated in vacuum dryer to remove water content to obtain a dehydrated VS extract. The dehydrated VS extract was further processed in a hammer mill to reduce the particle size to less than 200 microns. The micronized VS extract was subject to a secondary enzyme treatment. The secondary enzyme treatment was performed under the same conditions as the enzyme liquefaction step. The VS extract obtained was then reconstituted into liquid form to produce a whole pulse VS beverage. The foamability and foam stability of the VS beverage obtained by this method is shown in FIGS. 2 and 3 as B2.

### Example 3

A batch of VS was cleaned and flaked. The flaked VS underwent a wet milling process to produce a wet VS slurry. The wet VS slurry was then subject to an enzyme liquefaction which involved adding amylase to the wet VS slurry. The enzyme liquefaction treatment was performed under a temperature of about 50° C. for a period of about 30 minutes and at a pH 7. The slurry was then hydrolysed in the presence of water to obtain a liquefied VS starch. The liquefied VS starch was dehydrated in vacuum dryer to remove water content to obtain a dehydrated VS extract. The dehydrated VS extract was further processed in a hammer mill to reduce the particle size to less than 200 microns. The VS extract obtained was then reconstituted into liquid form to produce a whole pulse VS beverage. The foamability and foam stability of the VS beverage obtained by this method is shown in FIGS. 2 and 3 as B3.

### Example 4

In the application for making dairy-free set yoghurts, the VS extract is heat treated before it is transferred to an inoculation tank.

In this example, VS extract reconstituted in liquid form was inoculated (at 2-5%) with starter cultures including Lactobacillus bulgaricus and Streptococcus thermophilus and filled in containers (final packaging). The containers were transferred into incubation chambers (in the final packaging) at a temperature between 38° C. and 45° C. (ideally 42° C.) for a period of 4 to 7 hours, until the final pH reached 4.0 to 5.0 (ideally 4.3). After the fermentation process, the containers were chilled.

The table below shows an example of a spoonable yoghurt produced using the VS extract obtained by the methods of the present invention.

TABLE 1
Spoonable Yoghurt Plain (% values represent weight/weight)

| Ingredient | Percentage (%) |
|---|---|
| Plant-Based Solids | 10-15 |
| Sugar | 6-8 |
| Stabilizer Blend | <1 |
| Plant-Based Fibre | <1 |
| Culture | ≤1 |
| Water | 70-85 |

### Example 5

In the application for making dairy-free stirred yoghurts, the VS extract reconstituted in liquid form was heat treated, filled in a fermentation vessel, inoculated (at 2-5%) with starter cultures including Lactobacillus bulgaricus and Streptococcus thermophilus at a temperature between 38° C. and 45° C. (ideally 42° C.) for a period of 4 to 7 hours, until the final pH reached 4.0 to 5.0 (ideally 4.3). After the fermentation process, the yoghurt underwent a mixing process and one or more additives such as vitamins, minerals, flavours, probiotics, herbs, fruits and fruit preparations were added. Thereafter, the dairy alternative VS stirred yoghurt was filled into the final packaging and stored at chilled temperatures.

### Example 6

In the application for making dairy-free chilled drink yoghurts, the VS extract reconstituted in liquid form was heat treated, filled in a fermentation vessel, inoculated (at 2-5%) with starter cultures including Lactobacillus bulgaricus and Streptococcus thermophilus at a temperature between 38° C. and 45° C. (ideally 42° C.) for a period of 4 to 7 hours, until the final pH reached 4.0 to 5.0 (ideally 4.3). After the fermentation process, the yoghurt underwent a mixing and/or whipping process, and one or more additives such as vitamins, minerals, prebiotics, flavours, herbs, fruits and fruit preparations were added. Thereafter, the dairy alternative VS drink yoghurt was filled into the final packaging and stored at chilled temperatures.

The table below shows an example of a high protein ready-to-drink yoghurt produced using the VS extract obtained by the methods of the present invention.

TABLE 2
High Protein RTD Yoghurt (% values represent weight/weight)

| Ingredient | Percentage (%) |
|---|---|
| Plant-Based Solids | 8-15 |
| Plant-based Protein | 1-3 |
| Sugar | 6-8 |
| Stabilizer Blend | <1.5 |
| Culture | ≤1 |
| Water | 70-85 |

### Example 7

In the application for making dairy-free ambient drinkable yoghurts, the VS extract reconstituted in liquid form was heat treated, filled in a fermentation vessel, inoculated (at 2-5%) with starter cultures including Lactobacillus bulgaricus and Streptococcus thermophilus at a temperature between 38° C. and 45° C. (ideally 42° C.) for a period of 4 to 7 hours, until the final pH reached 4.0 to 5.0 (ideally 4.3). After the fermentation process, the yoghurt underwent a mixing and/or whipping process and one or more additives such as vitamins, minerals, flavours, herbs, fruits and fruit preparations were added. Thereafter, the mixture underwent a heat treatment, followed by packaging.

The table below shows an example of a dairy-free ambient drinkable yoghurt produced using the VS extract obtained by the methods of the present invention.

TABLE 3
Ambient Drinkable Yoghurt Plain (%
values represent weight/weight)

| Ingredient | Percentage (%) |
|---|---|
| Plant-Based Solids | 7-12 |
| Sugar | 6-8 |
| Stabilizer Blend | <1 |
| Culture | ≤1 |
| Water | 75-90 |

### Example 8

In the application for making non-dairy Kefir including novel combination of microorganisms, the VS extract reconstituted in liquid form was heat treated, filled in a fermentation vessel and adjusted to ambient temperature. The reconstituted VS extract was inoculated with starter cultures and incubated for 24 hours. The reconstituted VS extract was then transferred into final packaging and stored at chilled temperatures.

### Example 9

In the application for making non-dairy ice creams (hard and soft ice creams) and gelatos, the VS extract reconstituted in liquid form was processed with or without plant-based oils, flavours, sugars, probiotics, fruit and/or fruit preparations. Addition of emulsifiers and stabilizers was not required to achieve state of the art ice cream or gelato. Functional ice cream can be made to contain unique and beneficial plant probiotics surrounded by VS beverage components. After blending of the ingredients, a heat treatment was required, followed by a homogenization step. Thereafter, the freezing process began to take place. The final steps involved packaging and hardening of the ice cream.

### Example 10

In the application for making a plant-based mayonnaise, the VS extract reconstituted in liquid form was blended with ingredients such as vinegar, spices, salt, sugar and plant-based oils.

### Example 11

In the application for making a non-dairy fresh cheese (cottage cheese, ricotta, mascarpone, cream cheese, quark and mozzarella), the heat-treated VS extract in liquid form was processed with acid or rennet or chymosin obtained from microorganism.

### Example 12

In the application for making a non-dairy soft cheese (Camembert, Brie), the heat-treated VS extract in liquid form was processed with starter cultures and incubated between 30° C. to 35° C. Chymosin was added, followed by cutting the curd. The set curd was inoculated on the surface with camembert/brie mould. Once sufficient mould growth had taken place, the surface was treated with salt and the aging process started. After completion of ripening, the product was stored in chilled conditions. Processibility properties of VS extract is suitable for making melted cheese and processed cheese devoid of artificial ingredients and emulsifiers that are typically required.

### Example 13

In the application for making non-dairy firm/hard cheese (Emmentaler, Cheddar), the heat-treated VS extract in liquid form was processed with thermophilic cultures including propionic bacteria and fermented. Chymosin was added, followed by cutting the curd. The curd was pressed in a desired shaped and soaked in brine. After brining, the cheese underwent an aging step for up to 12 weeks.

### Example 14

In the application of making sweet spreads (e.g. chocolate spread), the heat-treated VS extract in liquid form was blended with natural sweeteners and cocoa powder. This was followed by heat treatment for shelf-life extension.

### Example 15

In the application of making savoury spreads (e.g. spring onion/sweet chilly), VS extract was blended with a source of acidifier, oil, salt, vegetables and spices, heat treated and packaged.

### Example 16

In the application of making a savoury tastemaker, a suspension of VS extract was processed with enzymes such as arabinase, cellulase, beta-glucanase, hemicellulase, xylanase, protease and glutaminase. After deactivation of the enzymes, the product was processed into a powder or used in liquid form.

### Example 17

In the application of making a soy sauce like product, rehydrated VS extract underwent a Koji and Moromi like fermentation process. Whole VS nut could also be used. The biotransformation product could be used in liquid form or further processed into a paste or powder.

### Example 18

In the application of making snacks, breakfast cereals and pasta, VS extract was blended with other food ingredients including plant protein extracts, concentrates and isolates, extruded, shaped, coated or non-coated.

### Example 19

In the application of making meat alternatives, VS extract was blended with water and other food ingredients such as fibers, plant proteins, mycoproteins, cell-based proteins, natural colours and globins. The VS extract underwent a twin screw extrusion process and further formulated with vegetable fats and other ingredients such as herbs and spices and formed into desired meat alternative applications.

### Example 20

In the application for making a tempeh like high protein snack, the VS extract was heat treated and inoculated with a starter culture that contains Rhizopus oligosporus and/or Rhizopus oryzae, and then fermented at a warm temperature (approximately 30° C.) for 24-48 hours or until the mycelium was binding the beverage precursor into a dense, white cake.

It should be appreciated by the person skilled in the art that variations and combinations of features described above, not being alternative or substitutes, may be combined to form yet further embodiments falling within the intended scope of the invention.

1. A method of producing a plant-based extract from Vigna subterranea, the method comprising:
flaking the Vigna subterranea seeds without dehulling the Vigna subterranea seeds;
subjecting the flaked Vigna subterranea to wet milling to obtain a slurry;
subjecting the slurry to enzyme liquefaction;
hydrolysing the slurry in water;
dehydrating the hydrolysed starch to obtain a dehydrated Vigna subterranea (VS) extract; andnum
reducing the particle size of the dehydrated VS extract by milling to obtain a micronized VS extract having an average particle size of less than 200 microns.

2. The method according to claim 1, further comprising:
subjecting the micronized VS extract to further processing steps including reconstitution, addition of pre-mix, homogenization and thermal treatment or a combination thereof.

3. The method according to claim 1, further comprising:
subjecting the micronized VS extract to a secondary enzyme treatment.

4. The method according to claim 1, wherein the enzyme liquefaction step comprises adding one or more enzymes selected from the group consisting of amylase enzyme or a combination of amylases (alpha- and beta-amylase) to the slurry to digest and liquefy the starch in the slurry.

5. The method according to claim 4, wherein the enzymes further include one or more enzymes selected from the group consisting of cellulase, hemi-cellulase, xylanase, arabinase, glucoamylase and maltogenic amylase.

6. The method according to claim 4, wherein the enzyme liquefaction step is performed at a temperature ranging from 30° C. to 85° C.

7. The method according to claim 6, wherein the enzyme liquefaction step is performed at a pH 5 to 7.

8. The method according to claim 3, wherein the secondary enzyme treatment step comprises adding one or more enzymes selected from the group consisting of amylase enzyme or a combination of amylases (alpha- and beta-amylase) to the micronized VS extract.

9. The method according to claim 8, wherein the enzymes further include one or more enzymes selected from the group consisting of cellulase, hemi-cellulase, xylanase, rabinose, glucoamylase and maltogenic amylase.

10. The method according to claim 8, wherein the secondary enzyme treatment is performed at a temperature ranging from 30° C. to 85° C.

11. The method according to claim 10, wherein the secondary enzyme treatment is performed at a pH 5 to 7.

12. A method of producing a plant-based extract from Vigna subterranea, the method comprising:
flaking the Vigna subterranea seeds without dehulling the Vigna subterranea seeds;
subjecting the flaked Vigna subterranea to wet milling to obtain a slurry;
heating the slurry to obtain a hydrolysed starch;
dehydrating the hydrolysed starch to obtain a dehydrated Vigna subterranea (VS) extract; and
reducing particle size of the dehydrated VS extract by milling to obtain a micronized VS extract having an average particle size of less than 200 micron.

13. The method according to claim 12, further comprising:
subjecting the micronized VS extract to further processing steps including reconstitution, addition of pre-mix, homogneization, thermal treatment, enzyme liquefaction and fermentation or a combination thereof.

14. The method according to claim 13, wherein the enzyme liquefaction step comprises adding one or more enzymes selected from the group consisting of amylase enzyme or a combination of amylases (alpha- and beta-amylase) to the micronized VS extract.

15. The method according to claim 14, wherein the enzymes further include one or more enzymes selected from the group consisting of cellulase, hemi-cellulase, xylanase, arabinase, glucoamylase and maltogenic amylase.

16. The method according to claim 14, wherein the enzyme liquefaction step is performed at a temperature ranging from 30° C. to 85° C.

17. The method according to claim 16, wherein the enzyme liquefaction step is performed at a pH 5 to 7.

18. The method according to claim 12, wherein the slurry is heated at a temperature of 50° C. to 85° C.

19. The method according to claim 13, wherein the step of fermentation comprises incubating the VS extract at a temperature ranging from 30° C. to 45° C. in the presence of lactic-acid producing microorganisms to develop textural and taste characteristics.

20. The method according to claim 1, wherein the milling is a pin milling, a roto milling, an air jet sieve milling or an air classifier milling.

21-26. (canceled)
